(19) United States
(12) Patent Application Publication
(10) Pub. No.: US 2016/0271812 A1
(43) Pub. Date: Sep. 22, 2016

(54) Locking structure for shears

(71) Applicant: Ching Chen YANG, Taichung City (TW)

(72) Inventor: Ching Chen YANG, Taichung City (TW)

(21) Appl. No.: 14/663,474

(22) Filed: Mar. 20, 2015

(51) Int. Cl. B26B 13/28

(52) U.S. Cl. CPC B26B 13/28

(57) ABSTRACT

A locking structure for a shears contains: a first cutting member, a second cutting member, and a connection post. The first cutting member includes a first handle and a first blade, and the second cutting member includes a second handle and a second blade. Between the first handle and the first blade of the first cutting member is defined a first connecting portion, and between the second handle and the second blade of the second cutting member is defined a second connecting portion. The first connecting portion has a first orifice, and the second connecting portion has a second orifice corresponding to the first orifice. The connection post is inserted through the first orifice and the second orifice and includes a ring, a tab, and a fixing section, wherein a total thickness of the tab and the ring is less than 4.5 mm.

### FIELD OF THE INVENTION

The present invention relates to a locking structure for a shears in which a total thickness of a tab and a ring is less than 4.5 mm, and a fixing section is stamped to shorten its length which extends out of a second cutting member, thus avoiding interference in a cutting process.

### BACKGROUND OF THE INVENTION

A conventional shears contains two cutting members which are connected together, wherein each cutting member has a blade fixed on a first end thereof and has a handle mounted on a second end thereof, such that the two handles are gripped to expand or retract the two blades, thus cutting a workpiece.

Another conventional shears is disclosed in TW Patent No. M240327 and contains two cutting members, wherein each cutting members has a blade disposed on a first end thereof and has a handle secured on a second end thereof, wherein two reinforcement portions are formed between a connection area between the two blades and the two handles of the two cutting members, and each reinforcement portion has a coupling portion made of non-metallic material, wherein each coupling portion has a gripping section with an orifice, such that the two reinforcement portions are located at two opposite sides of the two gripping sections, and each gripping potion has a contacting rib extending outwardly to each blade therefrom.

The two cutting members are connected together by means of a screwing post and a nut, and the coupling portion of each cutting member is close to a rear end of a cutting opening between the two blades, so when cutting a workpiece into two cut parts, a head end of the screwing post and the nut interfere the two cut parts easily.

The present invention has arisen to mitigate and/or obviate the afore-described disadvantages.

### SUMMARY OF THE INVENTION

The primary objective of the present invention is to provide a locking structure for a shears in which a total thickness of a tab and a ring is less than 4.5 mm, and a fixing section is stamped to shorten its length which extends out of a second cutting member, thus avoiding interference in a cutting process.

Another objective of the present invention is to provide a locking structure for a shears in which a thickness of the tab is decreased to prevent contacting with other hand tools or a blade sheath, thus cutting a workpiece easily.

To obtain the above objectives, a locking structure for a shears comprising: a first cutting member, a second cutting member, and a connection post.

The first cutting member includes a first handle formed on a first end thereof and includes a first blade arranged on a second end thereof, and the second cutting member includes a second handle formed on a first end thereof and includes a second blade arranged on a second end thereof, wherein between the first handle and the first blade of the first cutting member is defined a first connecting portion, and between the second handle and the second blade of the second cutting member is defined a second connecting portion, and wherein the first connecting portion has a first orifice formed thereon, the second connecting portion has a second orifice formed thereon and corresponding to the first orifice of the first connecting portion.

The connection post is inserted through the first orifice and the second orifice, and the connection post includes a ring fitted thereon and adjacent to the first orifice of the first cutting member, the connection post also includes a tab formed on a top end thereof, wherein a total thickness of the tab and the ring is less than 4.5 mm, and the connection post further includes a fixing section stamped on a bottom end thereof proximate to the second cutting member.

### BRIEF DESCRIPTION OF THE DRAWINGS

FIG. 1 is a perspective view showing the exploded components of a locking structure for a shears according to a preferred embodiment of the present invention.

FIG. 2 is a perspective view showing the assembly of the locking structure for the shears according to the preferred embodiment of the present invention.

FIG. 3 is a cross sectional view showing the assembly of a part of the locking structure for the shears according to the preferred embodiment of the present invention.

### DETAILED DESCRIPTION OF THE PREFERRED EMBODIMENTS

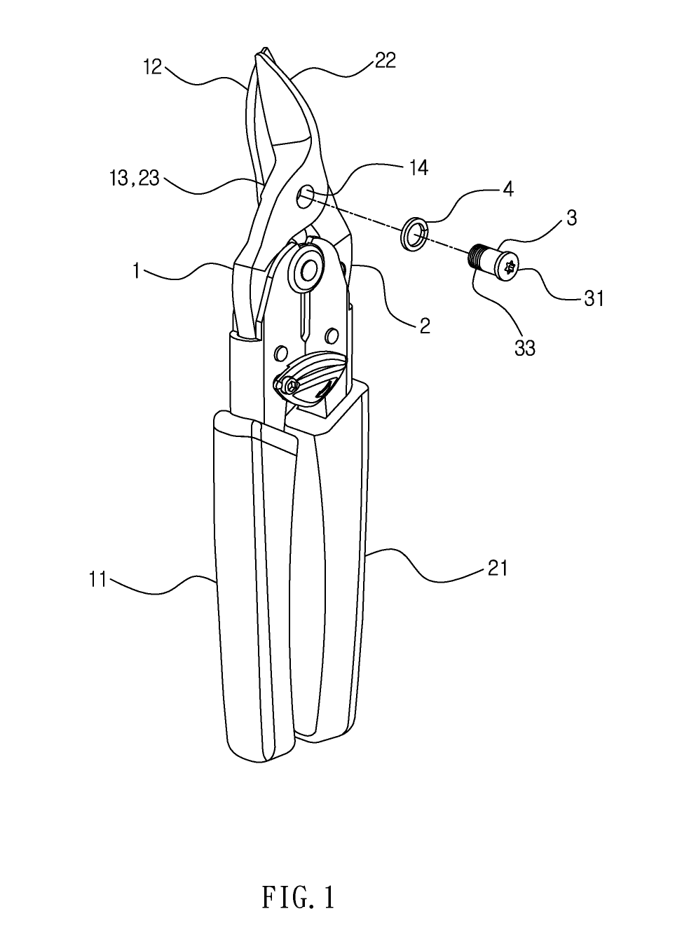

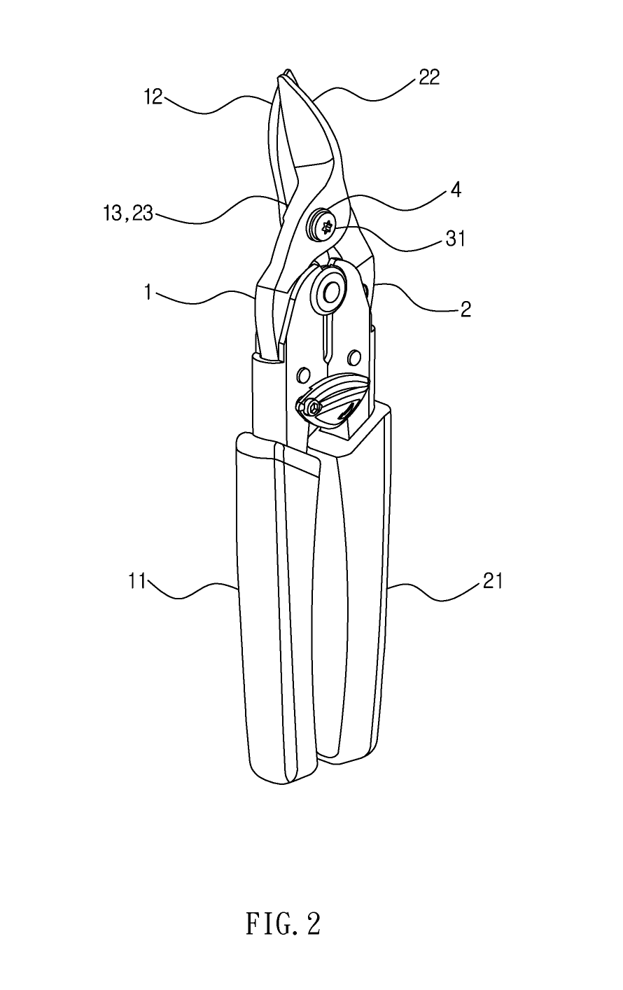

With reference to FIGS. 1 to 3, a locking structure for a shears according to a preferred embodiment of the present invention is shorten a connecting portion of the shears and comprises: a first cutting member 1, a second cutting member 2, and a connection post 3.

The first cutting member 1 includes a first handle 11 formed on a first end thereof and includes a first blade 12 arranged on a second end thereof, and the second cutting member 2 includes a second handle 21 formed on a first end thereof and includes a second blade 22 arranged on a second end thereof, wherein between the first handle 11 and the first blade 12 of the first cutting member 1 is defined a first connecting portion 13, and between the second handle 21 and the second blade 22 of the second cutting member 2 is defined a second connecting portion 23, and wherein the first connecting portion 13 has a first orifice 14 formed thereon, the second connecting portion 23 has a second orifice 24 formed thereon and corresponding to the first orifice 14 of the first connecting portion 13.

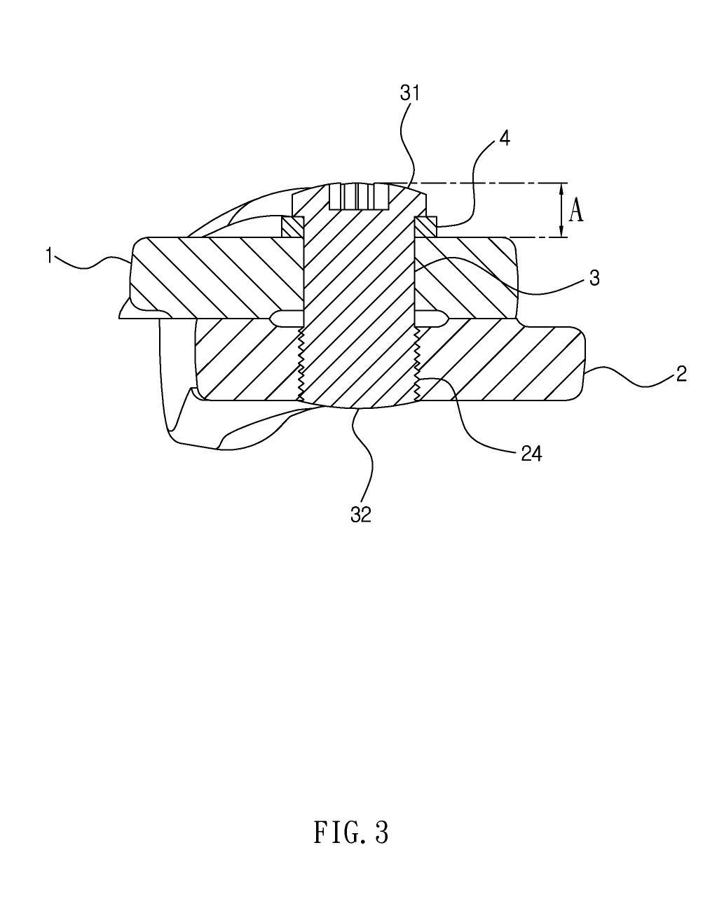

The connection post 3 is inserted through the first orifice 14 and the second orifice 24, and the connection post 3 includes a ring 4 fitted thereon and adjacent to the first orifice 14 of the first cutting member 1, the connection post 3 also includes a tab 31 formed on a top end thereof, wherein a total thickness A of the tab 31 and the ring 4 is less than 4.5 mm (as shown in FIG. 3), and the connection post 3 further includes a fixing section 32 stamped on a bottom end thereof proximate to the second cutting member 2.

Thereby, the connection post 3 is fixed between the first cutting member 1 and the second cutting member 2 by ways of the tab 31 and the fixing section 32, the total thickness of the tab 31 and the ring 4 is less than 4.5 mm, and the fixing section 32 is stamped to shorten its length which extends out of the second cutting member 2, thus avoiding inference in a cutting process.

Preferably, the second orifice 24 of the second cutting member 2 has threads formed therearound, and the connection post 3 further includes a threaded section 33 formed adjacent to the fixing section 32 to screw with the second orifice 24 of the second cutting member 2, such that the first cutting member 1 and the second cutting member 2 are screwed together by using the second orifice 23 of the second cutting member 2 and the threaded section 33 of the connection post 3.

Preferably, a peripheral side of the tab 31 is polygonal.

Preferably, the tab 31 has an arcuate face formed thereon.

Accordingly, the total thickness of the tab 31 and the ring 4 is less than 4.5 mm, and the fixing section 32 is stamped to shorten its length which extends out of the second cutting member 2, thus avoiding interference in the cutting process. In addition, a thickness of the tab 31 is decreased to prevent contacting with other hand tools or a blade sheath, thus cutting a workpiece easily.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A locking structure for a shears comprising: a first cutting member, a second cutting member, and a connection post, wherein
the first cutting member includes a first handle formed on a first end thereof and includes a first blade arranged on a second end thereof, and the second cutting member includes a second handle formed on a first end thereof and includes a second blade arranged on a second end thereof, wherein between the first handle and the first blade of the first cutting member is defined a first connecting portion, and between the second handle and the second blade of the second cutting member is defined a second connecting portion, and wherein the first connecting portion has a first orifice formed thereon, the second connecting portion has a second orifice formed thereon and corresponding to the first orifice of the first connecting portion;
the connection post is inserted through the first orifice and the second orifice, and the connection post includes a ring fitted thereon and adjacent to the first orifice of the first cutting member, the connection post also includes a tab formed on a top end thereof, wherein a total thickness of the tab and the ring is less than 4.5 mm, and the connection post further includes a fixing section stamped on a bottom end thereof proximate to the second cutting member.

2. The locking structure for the shears as claimed in claim 1, wherein the second orifice of the second cutting member has threads formed therearound, and the connection post further includes a threaded section formed adjacent to the fixing section to screw with the second orifice of the second cutting member.

3. The locking structure for the shears as claimed in claim 1, wherein a peripheral side of the tab is polygonal.

4. The locking structure for the shears as claimed in claim 1, wherein the tab has an arcuate face formed thereon.
